(19) United States
(12) Patent Application Publication
(10) Pub. No.: US 2023/0402599 A1
(43) Pub. Date: Dec. 14, 2023

(54) COMPOSITE CATHODE COMPRISING COATED CARBON FIBER AND ALL SOLID-STATE BATTERY COMPRISING THE SAME

(71) Applicant: Factorial Inc., Woburn, MA (US)

(72) Inventors: Minh Nguyen, Lowell, MA (US); Hyun Seok Kim, Lexington, MA (US); Toshinori Sugimoto, Woburn, MA (US); Jae Myung Lee, Belmont, MA (US)

(21) Appl. No.: 18/322,753

(22) Filed: May 24, 2023

Related U.S. Application Data
(60) Provisional application No. 63/389,383, filed on Jul. 15, 2022.
(60) Provisional application No. 63/350,665, filed on Jun. 9, 2022.

(51) Int. Cl. H01M 4/525; H01M 10/0562; H01M 4/505; H01M 10/44; H01M 4/62

(52) U.S. Cl. CPC H01M 4/525; H01M 10/0562; H01M 4/505; H01M 10/44; H01M 4/625; H01M 2300/008; H01M 2004/021

(57) ABSTRACT

Disclosed is a cathode composite layer for an all solid-state battery, comprising particles of a cathode active material (CAM), a solid electrolyte (SE), an electrically conductive carbon fiber coated with an oxide material. In one embodiment, the present disclosure provides an all solid-state battery comprising the cathode composite layer, wherein the battery has an increased capacity and cycle stability due to the reduced SE degradation.

### CROSS-REFERENCE

This application claims the benefits of U.S. Ser. No. 63/389,383, filed Jul. 15, 2022, and Ser. No. 63/350,665, filed Jun. 9, 2022, the entire contents of each is hereby incorporated by reference in its entirety.

### FIELD

This disclosure relates to a cathode layer or cathode composite layer for all solid-state battery.

### BACKGROUND

All-solid-state batteries (ASSBs) are considered as promising candidates for future energy storage devices as they may enable the use of lithium metal as anode material and lead to higher specific energies compared to conventional lithium-ion batteries based on organic liquid electrolytes. Thiophosphate-based solid electrolytes (SEs) seem to be particularly promising because of their high ionic conductivities, good mechanical compatibility, and relatively low costs. In general, poor thermodynamic stability of the SE, chemo-mechanical coupling, and interface kinetics are the remaining major challenges. In the cathode composite, side reactions include a) decomposition at the current collector/SE interface at high potentials, b) reactions between cathode active materials (CAM) and the SE resulting in resistive interfacial layers, and c) when a carbon conductive additive is used, decomposition reactions at the carbon/SE interface. Excessive degradation of the SE can reduce the Li⁺ mobility in the cathode layer and lead to capacity fade over time.

Composite cathodes comprising carbon fiber (CF) such as vapor-growth carbon fiber (VGCF) lead to higher initial capacities compared to a corresponding ASSB without CF because more CAM particles are electronically connected, resulting in a higher utilization of CAM. However, the initial capacity is not maintained, and rapid capacity fade is observed during cell cycling due to an increase rate of SE degradation (from both the CAM/SE and carbon/SE interfaces). The sulfide SE degrades on the CAM/SE and/or CF/SE interface when the potential is outside the potential stability window of the SE, for example higher than 2.1V for LPS (Li₇P₃S₁₁) electrolyte.

To minimize the impacts from the SE degradation, it is highly critical to reduce the SE degradation in the cathode composite layers, especially those with a high percentage of CAM, for example, no less than 86 wt %, and a low percentage of SE, for example, no more than 14 wt %.

U.S. Pat. No. 7,150,911 B2 describes a vapor grown carbon fiber (VGCF) coated with an electrically insulating material such as boron nitride as heat-conductive and electrical insulating filler. However, the resistivity of the coated VGCF as disclosed therein is 10×10³ Ω·cm or more, which may block the electrical connection pathways as required for an electrode layer.

US 20150228966 A1 discloses an all-solid-state battery using carbon fiber as a conducting agent in the CAM layer to improve the initial capacity due to the higher utilization of CAM by increasing electron conduction pathways. U.S. Pat. No. 9,219,271 B2 discloses an all-solid-state battery using conductive carbon additives in the cathode layer. However, neither discloses any coated carbon materials. The SE degradation problem remains.

### SUMMARY

In one embodiment, the present disclosure provides a cathode layer comprising CAM particles, sulfide solid electrolyte, and a carbon fiber (CF) coated with an oxide material (e.g., Li₃B₁₁O₁₈), wherein the CAM particles electronically contact with CF, e.g., upon pressure during fabrication. In one embodiment, the present disclosure provides an all-solid-state battery comprising the cathode layer. In one embodiment, the ASSB possesses an increased capacity and cycle stability due to the reduced SE degradation at the VGCF/SE interface.

### BRIEF DESCRIPTION OF THE FIGURES

FIG. 1 shows a representative structure of an ASSB with a cathode layer comprising CAM particle (1), sulfide SE (2), and VGCF (3) coated with an oxide material (4), wherein the CAM particle electronically contacts with VGCF.

FIG. 2 shows a TEM (transmission electron microscopy) image of a carbon fiber coated with a layer of Li₃B₁₁O₁₈ (LBO) with a thickness of roughly 1-2 nm.

FIG. 3 shows a plot of specific capacity vs. cycle of half-cells consisting of a Li metal anode, LPS SE, and cathode layer comprising particles of NCA88 (LiNi_{0.88}Co_{0.09}Al_{0.03}O₂) as CAM, and VGCF (uncoated or coated). Cycle 1 & 2 are cycled at 0.1C charge/discharge; cycle 3 & 4 are cycled at 0.33C charge/discharge, cycle 5 is cycled at 1.0C charge/discharge, and cycle 6-25 are cycled at 0.5C charge/discharge at 45° C. The cycle plots compare uncoated VGCF with 2, 20, 50, & 100 nm LBO coated VGCF.

FIG. 4 shows a plot of specific capacity vs. cycle of half-cells consisting of a Li metal anode, LPS as SE, and a cathode layer comprising particles of NCA88 (LiNi_{0.88}Co_{0.09}Al_{0.03}O₂) as CAM, and VGCF (uncoated or coated). Cycle 1 & 2 are cycled at 0.1C charge/discharge; cycle 3 & 4 are cycled at 0.33C charge/discharge, cycle 5 is cycled at 1.0C charge/discharge, and cycle 6-25 are cycled at 0.5C charge/discharge. The cycle plots compare uncoated VGCF with 20 nm B₂O₃, LBO (Li₃B₁₁O₁₈), Li₃BO₃, and 10 nm LiNbO₃.

### DETAILED DESCRIPTION OF THE DISCLOSURE

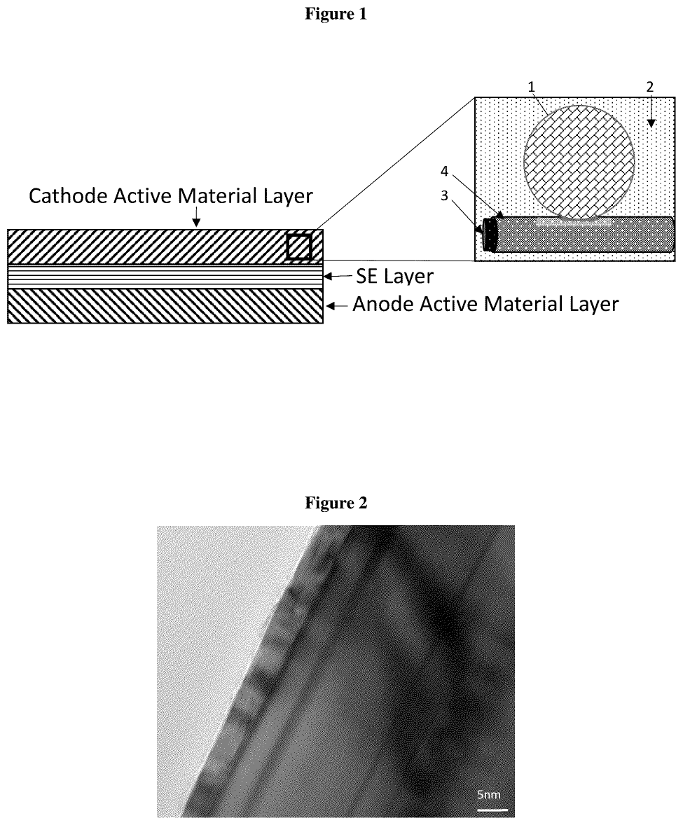

In one embodiment, the present disclosure provides a cathode composite layer comprising particles of a cathode active material (CAM) (1), a sulfide based solid electrolyte (2), and a carbon fiber (3) coated with an oxide material (4). In one embodiment, a representative structure is shown in FIG. 1.

In one embodiment, the sulfide solid electrolyte used in the present disclosure may be any sulfide solid electrolyte as long as it contains Li and S and has a desired lithium-ion conductivity. The sulfide solid electrolyte may be any of crystalline material, glass ceramic, and glass. Examples of the sulfide solid electrolyte include Li₂S—P₂S₅, Li₂S—P₂S₅—LiHa (“Ha” is one or more halogen elements), Li₂S—P₂S₅—P₂O₅, Li₂S—Li₃PO₄—P₂S₅, Li₃PS₄, Li₄P₂S₆, Li₁₀GeP₂S₁₂, Li_{3.25}Ge_{0.25}P_{0.75}S₄, Li₇P₃S₁₁, Li_{3.25}P_{0.95}S₄, and Li₇₋ₓPS₆₋ₓHaₓ (argyrodite-type solid electrolyte, “Ha” is one or more halogen elements, where 0.2<x<1.8). It has a concentration of between 1 wt % and 30 wt % in the cathode layer.

In one embodiment, the electrically conductive carbon fibers include, without limitation, vapor grown carbon fiber (VGCF), carbon nanotube (CNT), multi-walled carbon nanotubes (MWCNT), carbon nanofiber, and graphite fiber. The CFs have a BET measured specific surface area between 1-600 m²/g and an electrical resistance of no more than 0.5 Ω·cm. In one embodiment, the fiber has a concentration between 0.01 wt % and 5 wt % in the cathode layer.

In one embodiment, the oxide material is an electrically insulating material. In one embodiment, the oxide material is an inorganic oxide material. In one embodiment, the oxide material contains Li, a second element and a third element. In one embodiment, the second element is one or more elements from the groups 15 and 16 of the periodic table, such as O, N, S, P. In one embodiment, the third element is a transition metal or one or more elements from the groups 13 and 14 of the periodic table, such as B, C, Al, Si, Ga, and Ge. In one embodiment, the oxide material is an oxide containing Li, B, and, for example, one or two or more elements selected from the group consisting of B, Nb, Ti, Zr, Ta, Zn, W, and Al. In one embodiment, the oxide material is an inorganic oxide material including without limitation lithium borates, alumina, lithium zirconate (Li₂ZrO₃), LiNbO₃, Li₄SiO₄, Li₃PO₄, Li₂SiO₃, LiPO₃, Li₂SO₄, Li₂WO₄, Li₂MoO₄, LiAlO₂, Li₂TiO₃, Li₄Ti₅O₁₂, or a composite oxide thereof. In one embodiment, the lithium borates include without limitation Li₃B₁₁O₁₈, Li₃BO₃, Li₄B₂O₅, Li₆B₄O₉, LiBO₂, Li₂B₄O₇, Li₃B₇O₁₂, and LiB₃O₅. In one embodiment, the inorganic oxide is any other materials with a wide potential window of stability, for example from 1.9 V to 5.0 V. For example, the inorganic oxide material has a stable potential window of at least 1.5 V with reference to Li/Li+. In one embodiment, the inorganic oxide material has a stable potential window of at least 2.0 V with reference to Li/Li+. In one embodiment, the inorganic oxide material has a stable potential window of at least 2.5 V with reference to Li/Li⁺. In one embodiment, the inorganic oxide material has a stable potential window of at least 3.0 V with reference to Li/Li⁺. In one embodiment, the inorganic oxide material has a stable potential window of at least 4.0 V with reference to Li/Li⁺. In one embodiment, the inorganic oxide material has a stable potential window of at least 4.5 V with reference to Li/Li⁺. In one embodiment, the inorganic oxide material has a stable potential window of at least 5.1 V with reference to Li/Li⁺.

In one embodiment, the cathode composite layer is sandwiched between a cathode current collector and the solid electrolyte layer. In one embodiment, the cathode composite layer comprises a cathode active material (CAM) that requires both lithium ion (Li⁺) and electron (e−) connectivity with the SE layer and current collector, respectively. The Li⁺ connectivity is mainly provided by small particles of sulfide-based SE in the cathode composite mixture, and the e− connectivity is mainly provided by the CF. The sulfide-based SEs (such as LPS) have a high Li+ conductivity. However, they generally degrade at potentials below 1.7 V or above 2.1 V vs. Li/Li⁺ at the CAM/SE, CF/SE, and current collector/SE interface. The degraded byproducts generally have a lower Li+ conductivity, which in return requires a higher percentage of SE in the cathode composite layer, leading to a lower percentage of CAM. Therefore, the degradation narrows battery operating voltage windows, and prevents the ability to create high energy density batteries.

In one embodiment, the present disclosure discloses a carbon fiber coated with an oxide material layer or coating for a cathode composite layer. In one embodiment, the coating is Li₃B₁₁O₁₈ which has a wide voltage stability window of 1.9-4.7 V vs. Li/Li⁺. The present disclosure discovered that the thickness of the oxide material layer is critically important. A coating with a high thickness may fully block the electron conduction pathway, which is essential to enable operations of all solid-state batteries. A coating with a low thickness may lead to no difference when compared with uncoated carbon fiber and cannot reduce the degradation. On one hand, the coating has a certain thickness to provide a certain electrical insulation, thereby reducing SE degradation at the CF/SE interface. In one embodiment, the thickness is no less than 1 nm. In one embodiment, the thickness is no less than 2 nm. In one embodiment, the thickness is no less than 5 nm. In one embodiment, the thickness is no less than 10 nm. In one embodiment, the minimum thickness varies depending on several factors such as coating composition, intrinsic properties and the coating-CF interface. On the other hand, the coating shall not too thick and has a thickness t thin enough to be pierced by the hard CAM particles during battery formation (5000 lbs/in² press), thereby providing an electrical contact with the CAM particles and VGCF. In one embodiment, the thickness is no more than 200 nm. In one embodiment, the thickness is no more than 150 nm. In one embodiment, the thickness is no more than 100 nm. In one embodiment, the thickness is no more than 80 nm. In one embodiment, the thickness is no more than 50 nm. In one embodiment, the thickness is no more than 30 nm. In one embodiment, the maximum thickness varies depending on several factors such as coating composition, intrinsic properties and the coating-CF interface. In one embodiment, the cathode composite layer as disclosed in the present disclosure significantly reduced the degradation of SE, resulting in an improved cycle-life stability while achieving high initial specific capacities near 100% CAM utilization. In one embodiment, the coating has a thickness of 1-5 nm. In one embodiment, the coating has a thickness of 1-20 nm. In one embodiment, the coating has a thickness of 1-50 nm. In one embodiment, the coating has a thickness of 1-80 nm. In one embodiment, the coating has a thickness of 1-100 nm. The disclosure will be better understood by reference to the Experimental Details which follow, but those skilled in the art will readily appreciate that the specific experiments detailed are only illustrative and are not meant to limit the disclosure as described herein, which is defined by the claims which follow thereafter.

In one embodiment, the oxide material can transport lithium ion in the cathode composite layer. Without wishing to be bound any theories, the lithium ion conductivity is ascribed to the defects in the crystal structure of the inorganic oxide and a relatively small activation energy required for ion migration process. Islam, M. et al 2012 J. Phys.: Condens. Matter 24 203201.

In one embodiment, the present disclosure provides a composite layer as cathode for an all-solid-state battery, wherein the composite layer comprises particles of a cathode active material (CAM), a solid electrolyte, and a carbon fiber coated with an oxide material. In one embodiment, the oxide material is an electrically insulating material.

In one embodiment, the oxide material coated on the carbon fiber has a thickness of 1-80 nm.

In one embodiment, the oxide material coated on the carbon fiber has a thickness of 2-50 nm. In some embodiments, the oxide material coated on the carbon fiber has a thickness in a range from 1 nm to 100 nm, from 1 nm to 90 nm, from 1 nm to 80 nm, from 1 nm to 70 nm, from 1 nm to 60 nm, from 1 nm to 50 nm, from 1 nm to 40 nm, from 1 nm to 30 nm, from 1 nm to 25 nm, from 1 nm to 20 nm, from 1 nm to 15 nm, from 1 nm to 10 nm, from 2 nm to 100 nm, from 2 nm to 90 nm, from 2 nm to 80 nm, from 2 nm to 70 nm, from 2 nm to 60 nm, from 2 nm to 50 nm, from 2 nm to 40 nm, from 2 nm to 30 nm, from 2 nm to 25 nm, from 2 nm to 20 nm, from 2 nm to 15 nm, from 2 nm to 10 nm, from 5 nm to 100 nm, from 5 nm to 90 nm, from 5 nm to 80 nm, from 5 nm to 70 nm, from 5 nm to 60 nm, from 5 nm to 50 nm, from 5 nm to 40 nm, from 5 nm to 30 nm, from 5 nm to 25 nm, from 5 nm to 20 nm, from 5 nm to 15 nm, from 5 nm to 10 nm, from 10 nm to 100 nm, from 10 nm to 90 nm, from 10 nm to 80 nm, from 10 nm to 70 nm, from 10 nm to 60 nm, from 10 nm to 50 nm, from 10 nm to 40 nm, from 10 nm to 30 nm, from 10 nm to 25 nm, from 10 nm to 20 nm, from 10 nm to 15 nm, or any and all ranges and subranges therebetween. In some embodiments, the thickness is measured by observing the cross section of a dissected particle using a scanning electron microscope (SEM). In some embodiments, the thickness is measured on a transmission electron microscope (TEM).

In one embodiment, the particles of CAM have a weight percentage of no less than 65% in the composite layer.

In one embodiment, the carbon fiber coated with the oxide material has a weight percentage between 0.01 wt % and 5.0 wt % in the composite layer.

In one embodiment, the carbon fiber coated with the oxide material has a weight percentage between 1.0 wt % and 3.0 wt % in the composite layer.

In one embodiment, the oxide material is an inorganic oxide material with a wide window of voltage stability.

In one embodiment, the inorganic oxide material is selected from the group consisting of B₂O₃, Li₃B₁₁O₁₈, Li₃BO₃, Li₄B₂O₅, Li₆B₄O₉, LiBO₂, Li₂B₄O₇, Li₃B₇O₁₂, LiB₃O₅, LiNbO₃, Li₄SiO₄, Li₃PO₄, Li₂SiO₃, LiPO₃, Li₂SO₄, Li₂WO₄, Li₂MoO₄, Li₂ZrO₃, LiAlO₂, Li₂TiO₃, Li₄Ti₅O₁₂, or a composite oxide thereof.

In one embodiment, the inorganic oxide material is stable over a voltage ranging from 1.9V to 5.0V.

In some embodiments, the inorganic oxide material is a Li₃BO₃ doped Li₂CO₃ (LCBO), where the ratio of Li₂CO₃—Li₃BO₃ is expressed as Li₂₊ₓC₁₋ₓBₓO₃. In some embodiments, 0<x<1, 0<x≤0.90, 0<x≤0.80, 0<x≤0.70, 0<x≤0.60, 0<x≤0.50, 0<x≤0.45, 0<x≤0.40, 0<x≤0.35, 0<x≤0.30, 0<x≤0.25, 0<x≤0.20, 0<x≤0.15, 0<x≤0.10, 0.10<x<1, 0.10≤x≤0.90, 0.10≤x≤0.80, 0.10≤x≤0.70, 0.10≤x≤0.60, 0.10≤x≤0.50, 0.10≤x≤0.45, 0.10≤x≤0.40, 0.10≤x≤0.35, 0.10≤x≤0.30, 0.10≤x≤0.25, 0.10≤x≤0.20, 0.15≤x<1, 0.15≤x≤0.90, 0.15≤x≤0.80, 0.15≤x≤0.70, 0.15≤x≤0.60, 0.15≤x≤0.50, 0.15≤x≤0.45, 0.15≤x≤0.40, 0.15≤x≤0.35, 0.15≤x≤0.30, 0.15≤x≤0.25, 0.20≤x<1, 0.20≤x≤0.90, 0.20≤x≤0.80, 0.20≤x≤0.70, 0.20≤x≤0.60, 0.20≤x≤0.50, 0.20≤x≤0.45, 0.20≤x≤0.40, 0.20≤x≤0.35, 0.20≤x≤0.30, 0.25≤x<1, 0.25≤x≤0.90, 0.25≤x≤0.80, 0.25≤x≤0.70, 0.25≤x≤0.60, 0.25≤x≤0.50, 0.25≤x≤0.45, 0.25≤x≤0.40, 0.25≤x≤0.35, 0.30≤x<1, 0.30≤x≤0.90, 0.30≤x≤0.80, 0.30≤x≤0.70, 0.30≤x≤0.60, 0.30≤x≤0.50, 0.30≤x≤0.45, 0.30≤x≤0.40, 0.35≤x<1, 0.35≤x≤0.90, 0.35≤x≤0.80, 0.35≤x≤0.70, 0.35≤x≤0.60, 0.35≤x≤0.50, 0.35≤x≤0.45, 0.40≤x<1, 0.40≤x≤0.90, 0.40≤x≤0.80, 0.40≤x≤0.70, 0.40≤x≤0.60, 0.40≤x≤0.50, 0.45≤x<1, 0.45≤x≤0.90, 0.45≤x≤0.80, 0.45≤x≤0.70, 0.45≤x≤0.60, 0.50≤x<1, 0.50≤x≤0.90, 0.50≤x≤0.80, 0.50≤x≤0.70, 0.50≤x≤0.60, 0.70≤x<1, 0.70≤x≤0.90, 0.70≤x≤0.80, and all ranges and subranges therebetween.

In one embodiment, the solid electrolyte is a sulfur-containing inorganic electrolyte.

In one embodiment, the solid electrolyte is selected from the group consisting of Li₂S—P₂S₅, Li₂S—P₂S₅—LiHa, Li₂S—P₂S₅—P₂O₅, Li₂S—Li₃PO₄—P₂S₅, Li₃PS₄, Li₄P₂S₆, Li₁₀GeP₂S₁₂, Li_{3.25}Ge_{0.25}P_{0.75}S₄, Li₇P₃S₁₁, Li_{3.25}P_{0.95}S₄, and Li₇₋ₓPS₆₋ₓHaₓ, wherein “Ha” is one or more halogen elements, and 0.2<x<1.8).

In one embodiment, the solid electrolyte has a weight percentage between 1 wt % and 35 wt % in the composite layer. In some embodiments, the solid electrolyte may have a concentration in a range from 1 wt % to 35 wt %, 1 wt % to 30 wt %, 1 wt % to 25 wt %, 1 wt % to 20 wt %, 1 wt % to 15 wt %, 1 wt % to 10 wt %, 5 wt % to 35 wt %, 5 wt % to 30 wt %, 5 wt % to 25 wt %, 5 wt % to 20 wt %, 5 wt % to 15 wt %, 10 wt % to 35 wt %, 10 wt % to 30 wt %, 10 wt % to 25 wt %, 10 wt % to 20 wt %, 15 wt % to 35 wt %, 15 wt % to 30 wt %, 15 wt % to 25 wt %, 20 wt % to 30 wt %, or any and all ranges and subranges therebetween in the composite layer.

In one embodiment, the CAM is selected from the group consisting of LiₓMn_{1-y}M_{y}A₂, LiₓMn_{1-y}M_{y}O_{2-z}X_{z}, LiₓMn₂O_{4-z}X_{z}, LiₓMn_{2-y}M_{y}A₄, LiₓCo_{1-y}M_{y}A₂, LiₓCo_{1-y}M_{y}O_{2-z}X_{z}, LiₓNi_{1-y}M_{y}A₂, LiₓNi_{1-y}M_{y}O_{2-z}X_{z}, LiₓNi_{1-y}Co_{y}O_{2-z}X_{z}, LiₓNi_{1-y-z}Co_{y}M_{z}Aₐ, LiₓNi_{1-y-z}Co_{y}M_{z}O₂₋ₐXₐ, LiₓNi_{1-y-z}Mn_{y}M_{z}Aₐ, LiₓNi_{1-y-z}Mn_{y}M_{z}O₂₋ₐXₐ, wherein 0.95≤x≤1.1, 0≤y≤0.5, 0≤z≤0.5, 0≤a≤2; M is selected from the group consisting of Al, Ni, Co, Mn, Cr, Fe, Mg, Sr, V, and rare earth elements; A is selected from the group consisting of O, F, S, and P; and X is selected from the group consisting of F, S, and P.

In some embodiments, the CAM is at least one selected from the group consisting of LiₓMO₂, LiₓNi_{1-y-z}Co_{y}M1_{z}O₂ and LiₓNi_{1-y-z}Mn_{y}M2_{z}O₂, wherein M is at least one selected from the group consisting of Ni, Co, Mn, Al, B, Fe, Mg, Ca, Sr, Sc, Y, Ti, Zr, V, Nb, Ta, Cr, Mo, W, Rh, Pd, Cu, Zn, Cd, Ga, In, Sn, and rare earth elements, wherein M1 is at least one selected from the group consisting of Mn, Al, B, Fe, Mg, Ca, Sr, Sc, Y, Ti, Zr, V, Nb, Ta, Cr, Mo, W, Rh, Pd, Cu, Zn, Cd, Ga, In, Sn, and rare earth elements, wherein M2 is at least one selected from the group consisting of Co, Al, B, Fe, Mg, Ca, Sr, Sc, Y, Ti, Zr, V, Nb, Ta, Cr, Mo, W, Rh, Pd, Cu, Zn, Cd, Ga, In, Sn, and rare earth elements, and wherein 0.95≤x≤1.1, 1−y−z>0, 0<y≤0.5, 0≤z≤0.5.

In some embodiments, the CAM is at least one selected from the group consisting of LiₓMO₂, LiₓNi_{1-y-z}Co_{y}M1_{z}O₂ and LiₓNi_{1-y-z}Mn_{y}M2_{z}O₂, wherein M is at least one selected from the group consisting of Al, B, Fe, Mg, Ca, Sr, Sc, Y, Ti, Zr, V, Nb, Ta, Cr, Mo, W, Rh, Pd, Cu, Zn, Cd, Ga, In, Sn, and rare earth elements, wherein M1 is at least one selected from the group consisting of Mn, Al, B, Fe, Mg, Ca, Sr, Sc, Y, Ti, Zr, V, Nb, Ta, Cr, Mo, W, Rh, Pd, Cu, Zn, Cd, Ga, In, Sn, and rare earth elements, wherein M2 is at least one selected from the group consisting of Co, Al, B, Fe, Mg, Ca, Sr, Sc, Y, Ti, Zr, V, Nb, Ta, Cr, Mo, W, Rh, Pd, Cu, Zn, Cd, Ga, In, Sn, and rare earth elements, and wherein 0.95≤x≤1.1, 1−y−z>0, 0<y≤0.5, 0<z≤0.5.

In some embodiments, the CAM is surface-doped by a doping element which is at least one selected from the group consisting of Ni, Co, Mn, Al, B, Fe, Mg, Ca, Sr, Sc, Y, Ti, Zr, V, Nb, Ta, Cr, Mo, W, Rh, Pd, Cu, Zn, Cd, Ga, In, Sn, Si, Ge, S, P, and rare earth elements.

In some embodiments, the CAM is in the form of particles having an average diameter in a range from about 1 μm to about 15 μm, about 1 μm to about 12 μm, about 1 μm to about 10 μm, about 1 μm to about 7 μm, about 1 μm to about 6 μm, about 3 μm to about 15 μm, about 3 μm to about 12 μm, about 3 μm to about 10 μm, about 3 μm to about 7 μm, about 3 μm to about 6 μm, about 5 μm to about 15 μm, about 5 μm to about 12 μm, about 5 μm to about 10 μm and all ranges and subranges therebetween. In some embodiments, the coated CAM may have a concentration in a range from about 50 wt % to about 99 wt %, about 50 wt % to about 95 wt %, about 50 wt % to about 90 wt %, about 50 wt % to about 85 wt %, about 50 wt % to about 80 wt %, about 55 wt % to about 99 wt %, about 55 wt % to about 95 wt %, about 55 wt % to about 90 wt %, about 55 wt % to about 85 wt %, about 55 wt % to about 80 wt %, about 60 wt % to about 99 wt %, about 60 wt % to about 95 wt %, about 60 wt % to about 90 wt %, about 60 wt % to about 85 wt %, about 60 wt % to about 80 wt %, about 65 wt % to about 99 wt %, about 65 wt % to about 95 wt %, about 65 wt % to about 90 wt %, about 65 wt % to about 85 wt %, about 65 wt % to about 80 wt %, about 70 wt % to about 99 wt %, about 70 wt % to about 95 wt %, about 70 wt % to about 90 wt %, about 70 wt % to about 85 wt %, about 70 wt % to about 80 wt %, and all range and subranges therebetween in the cathode layer. In some embodiments, the CAM particles may be polycrystalline or single crystalline. In some embodiments, the CAM particles may have a single particle size distribution or multiple particle size distributions.

In some embodiments, the CAM contains element Ni with a molar fraction of at least 50%, at least 55%, at least 60%, at least 65%, at least 70%, at least 75%, at least 80%, or at least 85% in all metal elements other than lithium.

In one embodiment, the particles have an average diameter of 1-15 μm.

In one embodiment, the present disclosure provides an all solid-state battery (ASSB), comprising:
a) the composite layer as a positive electrode, and
b) a solid electrolyte layer between the positive electrode and a negative electrode.

In one embodiment, the solid electrolyte layer is made of a second solid electrolyte, which is the same as or different from the solid electrolyte in the cathode composite layer.

In one embodiment, the composite layer comprises at least 65 wt % of the particles of CAM.

In one embodiment, the ASSB has an initial discharging specific capacity of at least 180 mAh/g at a discharge rate of 0.5C.

In one embodiment, the ASSB has an initial discharging specific capacity of at least 200 mAh/g at a discharge rate of 0.1C.

In one embodiment, after 20 cycles at a discharge rate of 0.5C, the ASSB has a specific capacity of at least 180 mAh/g and a capacity retention rate of at least 95%.

The disclosure will be better understood by reference to the Experimental Details which follow, but those skilled in the art will readily appreciate that the specific experiments detailed are only illustrative, and are not meant to limit the disclosure as described herein, which is defined by the claims which follow thereafter.

It is to be noted that the transitional term “comprising”, which is synonymous with “including”, “containing” or “characterized by”, is inclusive or open-ended and does not exclude additional, un-recited elements or method steps.

### Example 1

A carbon fiber coated with an oxide material was prepared using traditional sol-gel methods. For Li₃B₁₁O₁₈ coating, stoichiometric amounts of a Li precursor (such as lithium acetate or lithium metal) and B precursor (such as triisopropyl borate) were dissolved in a dry solvent (such as ethanol), forming a coating solution comprising the lithium precursor and borate precursor. The coating solution was added to a pre-determined amount of CFs (VGCF-H, fiber diameter 150 nm, fiber length 10-20 μm, BET surface area of 13 m²/g, aspect ratio 10-500, true density 2.0 g/cm³, apparent density VGCF(R) (standard type) 0.04 g/cm, single fiber specific resistance 1×10⁻⁴ Ωcm). The pre-determined amount of CF is calculated to give a desired coating thickness based on the CF BET surface area and bulk density of the coating phase (2.16 g/cm3 for Li₃B₁₁O₁₈). The mixture is stirred for 30 minutes followed by solvent removal via vacuum while being sonicated, leading to a gel of CF coated with the Li precursor and B precursor. The CF gel is then annealed for 1 hour at 300° C. under an oxygen flow to form the carbon fiber coated with a Li₃B₁₁O₁₈ layer. The specific discharge capacities and cycle life retentions of the various cathode layers with coated and uncoated CFs is summarized in Table 1. The cathode layer is comprised of 65 wt % CAM (NCA88), 5 wt % CF (coated or uncoated), and 30 wt % LPS. The cathode layers are electrochemically evaluated in torque-cells using Li metal on copper as the anode and LPS as the SE. The cells were cycled from 2.8V to 4.25V at 0.1C charge/discharge for cycles 1 and 2, 0.33C charge/discharge for cycles 3 and 4, 1.0C charge/discharge for cycle 5, and 0.5C charge/discharge for cycles 6 to 25 at 45° C.

Carbon fiber or other electron conductive material is necessary to electronically connect all the CAM particles in the cathode layer to achieve high initial discharge capacities. However, the decomposition of the SE in contact with CF leads to substantial fading. In the present disclosure, this was addressed by an oxide material (for example, LBO (Li₃B₁₁O₁₈)) with a thickness of 2-50 nm on CF. The coating thickness is calculated stoichiometrically using the BET surface area of the CF, the bulk density of the coating composition, and the mass/moles of reagents in the coating solution (assuming 100% reagent utilization). The coating thickness is confirmed from TEM analysis. A representative TEM image is shown in FIG. 2.

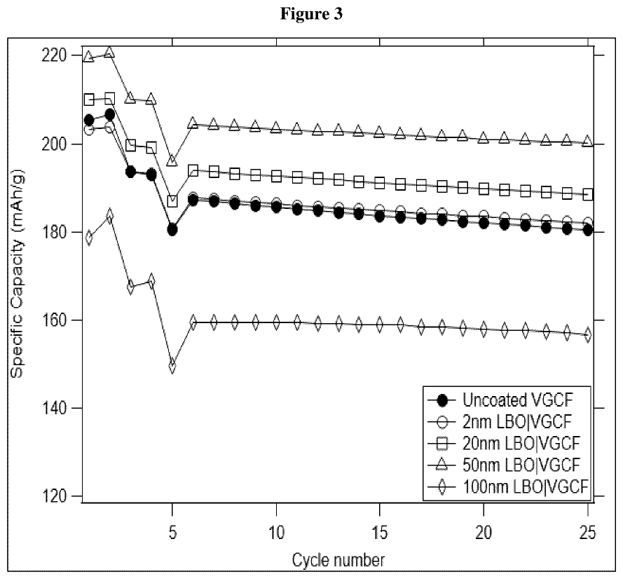

The coated CF decreased the fading of the discharging capacity while simultaneously maintaining the initial battery performance at a high level. For example, the initial discharging capacity is 205.33 mAh/g at a discharging rate of 0.1C for a half-cell comprising uncoated VGCF. With a 2, 20 and 50 nm coating of LBO on VGCF, the initial discharging capacities are 203.91 mAh/g, 206.76 mAh/g, and 219.23 mAh/g, respectively. When the LBO's thickness is 100 nm, the initial discharge capacity is decreased to 178.73 mAh/g. The coated CF reduces cell decomposition effectively, as evident by the cycle-life capacity retention after 20 cycles at 0.5C in Table 1 and FIG. 3, and may be crucial to realize high capacity SSBs as evident by an increase in initial discharge capacity at 0.1C rate that approaches the theoretical capacity of the CAM (219.8 mAh/g for NCA88—LiNi_{0.88}Co_{0.09}Al_{0.03}O₂).

TABLE 1
Initial discharge (dChg.) capacities (Cap.) at different C-rates for half-cells using
uncoated VGCF and LBO coated VGCF of different coating thicknesses.

| | Initial | | Initial | Initial | | |
|---|---|---|---|---|---|---|
| | 0.1C | | 1.0C | 0.5C | 20^{th} Cycle | Cycle Life |
| | dChg. | Initial 0.33C | dChg. | dChg. | 0.5C dChg. | 0.5C dChg. |
| | Cap. | dChg. Cap. | Cap. | Cap. | Cap. | Capacity |
| Sample | (mAh/g) | (mAh/g) | (mAh/g) | (mAh/g) | mAh/g) | Retention^{a} |
| Uncoated VGCF | 205.33 | 193.56 | 180.47 | 187.30 | 180.43 | 96.33% |
| 2 nm LBO\|VGCF | 203.91 | 193.27 | 179.10 | 186.78 | 182.61 | 97.77% |
| 20 nm LBO\|VGCF | 206.76 | 196.23 | 183.35 | 190.77 | 186.71 | 97.87% |
| 50 nm LBO\|VGCF | 219.23 | 209.96 | 195.69 | 204.41 | 200.10 | 97.90% |
| 100 nm LBO\|VGCF | 178.73 | 167.56 | 149.58 | 159.39 | 156.70 | 98.31% |

^{a}The cycle life 0.5C dChg. capacity retention is calculated by dividing the 20^{th} cycle 0.5C dChg. capacity by the initial 0.5C dChg. capacity and multiplying by 100%.

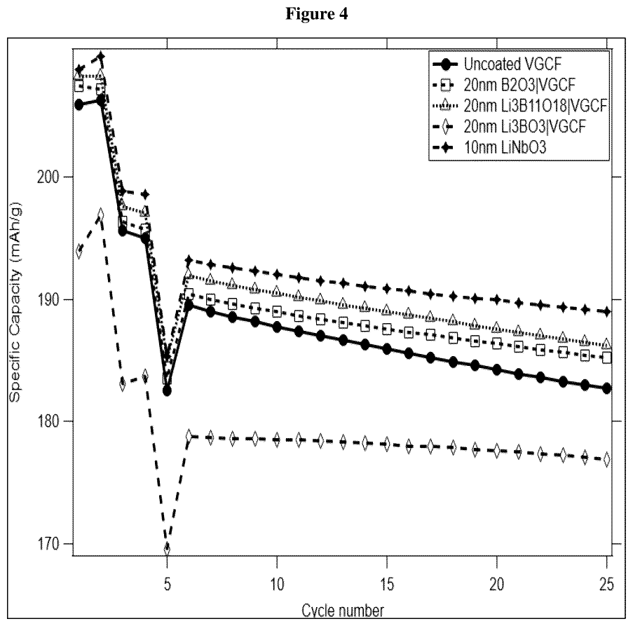

The VGCF coating is not limited to Li containing oxides or lithium borates. FIG. 4 shows the cycling performance of uncoated VGCF with 20 nm B₂O₃, 20 nm Li₃B₁₁O₁₈, 20 nm Li₃BO₃, and 10 nm LiNbO₃. The cathode layer is comprised of 65 wt % CAM (NCA88), 5 wt % CF (coated or uncoated), and 30 wt % LPS. The cathode layers are electrochemically evaluated in torque-cells using Li metal on copper as the anode and LPS as the SE. The cells were cycled from 2.8V to 4.25V at 0.1C charge/discharge for cycles 1 and 2, 0.33C charge/discharge for cycles 3 and 4, 1.0C charge/discharge for cycle 5, and 0.5C charge/discharge for cycles 6 to 25. All coating compositions except Li₃BO₃ showed enhanced discharge capacities and 25^{th} cycle capacity retention compared to uncoated VGCF.

TABLE 2
Initial discharge (dChg.) capacities (Cap.) at different C-rates for half-cells using
uncoated VGCF and 20 nm B₂O₃, Li₃B₁₁O₁₈, Li₃BO₃, and 10 nm LiNbO₃ coated VGCF.

| | | Initial | | | 20^{th} Cycle | Cycle |
|---|---|---|---|---|---|---|
| | Initial 0.1C | 0.33C | Initial 1.0C | Initial 0.5C | 0.5C dChg. | Life |
| | dChg. Cap. | dChg. Cap. | dChg. Cap. | dChg. Cap. | Cap. | Capacity |
| Sample Name | (mAh/g) | (mAh/g) | (mAh/g) | (mAh/g) | (mAh/g) | Retentionª |
| Uncoated VGCF | 205.33 | 193.56 | 180.47 | 187.30 | 180.43 | 96.33% |
| 20 nm B₂O₃\|VGCF | 208.11 | 196.93 | 184.07 | 191.02 | 185.84 | 97.29% |
| 20 nm Li₃B₁₁O₁₈\|VGCF | 206.76 | 196.23 | 183.35 | 190.77 | 186.71 | 97.87% |
| 20 nm Li₃BO₃\|VGCF | 196.29 | 185.38 | 171.04 | 179.77 | 175.71 | 97.74% |
| 10 nm LiNbO₃\|VGCF | 208.76 | 198.83 | 185.28 | 193.20 | 188.97 | 97.79% |

^{a}The cycle life 0.5C dChg. capacity retention is calculated by dividing the 20^{th} cycle 0.5C dChg. capacity by the initial 0.5C dChg. capacity and multiplying by 100%.

What is claimed is:

1. A composite layer, comprising:
particles of a cathode active material (CAM);
a solid electrolyte; and
a carbon fiber coated with an oxide material.

2. The composite layer of claim 1, wherein the oxide material coated on the carbon fiber has a thickness of 1-70 nm.

3. The composite layer of claim 1, wherein the oxide material coated on the carbon fiber has a thickness of 2-50 nm.

4. The composite layer of claim 1, wherein the particles of CAM have a weight percentage of no less than 65% in the composite layer.

5. The composite layer of claim 1, wherein the carbon fiber coated with the oxide material has a weight percentage between 0.01 wt % and 5.0 wt % in the composite layer.

6. The composite layer of claim 1, wherein the carbon fiber coated with the oxide material has a weight percentage between 1.0 wt % and 3.0 wt % in the composite layer.

7. The composite layer of claim 1, wherein the oxide material is an inorganic oxide material.

8. The composite layer of claim 7, wherein the inorganic oxide material is selected from the group consisting of B₂O₃, Li₃B₁₁O₁₈, Li₄B₂O₅, Li₆B₄O₉, LiBO₂, Li₂B₄O₇, Li₃B₇O₁₂, LiB₃O₅, LiNbO₃, Li₄SiO₄, Li₃PO₄, Li₂SiO₃, LiPO₃, Li₂SO₄, Li₂WO₄, Li₂MoO₄, Li₂ZrO₃, LiAlO₂, Li₂TiO₃, Li₄Ti₅O₁₂, and a composite oxide thereof.

9. The composite layer of claim 7, wherein the inorganic oxide is stable over a voltage ranging from 1.9V to 5.0V.

10. The composite layer of claim 1, wherein the solid electrolyte is a sulfur-containing inorganic electrolyte.

11. The composite layer of claim 1, wherein the solid electrolyte is selected from the group consisting of Li₂S—P₂S₅, Li₂S—P₂S₅—LiHa, Li₂S—P₂S₅—P₂O₅, Li₂S—Li₃PO₄—P₂S₅, Li₃PS₄, Li₄P₂S₆, Li₁₀GeP₂S₁₂, Li_{3.25}Ge_{0.25}P_{0.75}S₄, Li₇P₃S₁₁, Li_{3.25}P_{0.95}S₄, and Li₇₋ₓPS₆₋ₓHaₓ, wherein “Ha” is one or more halogen elements, and 0.2<x<1.8).

12. The composite layer of claim 1, wherein the solid electrolyte has a weight percentage between 1 wt % and 35 wt % in the composite layer.

13. The composite layer of claim 1, wherein the CAM is at least one selected from the group consisting of LiₓMO₂, LiₓNi_{1-y-z}Co_{y}M1_{z}O₂ and LiₓNi_{1-y-z}Mn_{y}M2_{z}O₂, wherein M is at least one selected from the group consisting of Ni, Co, Mn, Al, B, Fe, Mg, Ca, Sr, Sc, Y, Ti, Zr, V, Nb, Ta, Cr, Mo, W, Rh, Pd, Cu, Zn, Cd, Ga, In, Sn, and rare earth elements, wherein M1 is at least one selected from the group consisting of Mn, Al, B, Fe, Mg, Ca, Sr, Sc, Y, Ti, Zr, V, Nb, Ta, Cr, Mo, W, Rh, Pd, Cu, Zn, Cd, Ga, In, Sn, and rare earth elements, wherein M2 is at least one selected from the group consisting of Co, Al, B, Fe, Mg, Ca, Sr, Sc, Y, Ti, Zr, V, Nb, Ta, Cr, Mo, W, Rh, Pd, Cu, Zn, Cd, Ga, In, Sn, and rare earth elements, and wherein 0.95≤x≤1.1, 1−y−z>0, 0<y≤0.5, 0≤z≤0.5.

14. The composite layer of claim 1, wherein the particles have an average diameter of 1-15 μm.

15. An all solid-state battery (ASSB), comprising:
a) the composite layer of claim 1 as a positive electrode;
b) a negative electrode; and
c) a solid electrolyte layer between the positive electrode and the negative electrode.

16. The ASSB of claim 15, wherein the solid electrolyte layer is the same as or different from the solid electrolyte in the cathode composite layer.

17. The ASSB of claim 15, wherein the composite layer comprises at least 65 wt % of the particles of CAM.

18. The ASSB of claim 17, wherein the ASSB has an initial discharging specific capacity of at least 180 mAh/g at a discharge rate of 0.5C.

19. The ASSB of claim 17, wherein the ASSB has an initial discharging specific capacity of at least 200 mAh/g at a discharge rate of 0.1C.

20. The ASSB of claim 17, wherein, when the ASSB is charged to 4.25 V and discharged to 2.8 V for 20 cycles at 45° C. at 0.1C for cycles 1 and 2, 0.33C for cycles 3 and 4, 1.0C for cycle 5, and 0.5C for cycles 6 to 20, the ASSB exhibits a specific capacity of at least 180 mAh/g and a cycle life retention rate of at least 95% at the 20^{th} cycle, wherein the cycle life retention rate is the ratio of the discharge specific capacity at the 20^{th} cycle to the initial discharge specific capacity at 0.5C at 45° C.
